(19) United States
(12) Patent Application Publication
(10) Pub. No.: US 2024/0234811 A1
(43) Pub. Date: Jul. 11, 2024

(54) FREE-STANDING GEL MEMBRANE FOR ELECTROCHEMICAL CELL

(71) Applicant: GM GLOBAL TECHNOLOGY OPERATIONS LLC, Detroit, MI (US)

(72) Inventors: Zhe LI, Shanghai (CN); Qili SU, Shanghai (CN); Meiyuan WU, Shanghai (CN); Yong LU, Shanghai (CN); Haijing LIU, Shanghai (CN)

(73) Assignee: GM GLOBAL TECHNOLOGY OPERATIONS LLC, Detroit, MI (US)

(21) Appl. No.: 18/131,172

(22) Filed: Apr. 5, 2023

(30) Foreign Application Priority Data
Jan. 6, 2023 (CN) 202310016594.4

(51) Int. Cl. H01M 10/0565; H01M 10/0562

(52) U.S. Cl. CPC H01M 10/0565; H01M 10/0562; H01M 2300/0085; H01M 2300/0091

(57) ABSTRACT

An electrochemical cell that cycles lithium ions includes a positive electrode that includes a positive electroactive material, a negative electrode that includes a negative electroactive material, and a free-standing separating layer disposed between the positive electrode and the negative electrode. The free-standing separating layer includes a gel membrane that includes a polymer host and a liquid electrolyte and an integrated structural component disposed within the gel membrane. The integrated structural component may be selected from the group consisting of: a plurality of solid-state electrolyte particles, a nonwoven material, and a combination thereof.

### CROSS-REFERENCE TO RELATED APPLICATIONS

This application claims the benefit and priority of Chinese Application No. 202310016594.4, filed Jan. 6, 2023. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid or semi-solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte layer (or solid-state separator), the solid-state electrolyte layer (or solid-state separator) may physically separate the electrodes so that a distinct separator is not required.

Semi-solid batteries have advantages over batteries that include a separator and a liquid electrolyte. These advantages can include a longer shelf life with lower self-discharge, simpler thermal management, a reduced need for packaging, and the ability to operate within a wider temperature window. For example, semi-solid electrolytes are generally non-volatile and non-flowing, so as to allow cells to be cycled under harsher conditions without experiencing diminished potential or thermal runaway, which can potentially occur with the use of liquid electrolyte. However, semi-solid or gel electrolytes prepared by hot casting often include pores and have poor mechanical strength, which can cause inner short circuit in the battery. It would be desirable to develop high-performance semi-solid or gel materials and battery designs, as well as methods of making and using the same, that can address these challenges.

### SUMMARY

This section provides a general summary of the disclosure, and is not a comprehensive disclosure of its full scope or all of its features.

The present disclosure relates to an electrochemical cell that cycles lithium ions, and more particularly, to electrochemical cells including gel polymer electrolytes (for example, a free-standing gel membrane), and methods of making and using the same.

In various aspects, the present disclosure provides a free-standing separating layer for an electrochemical cell. The free-standing separating layer may include a gel membrane that includes a polymer host and a liquid electrolyte, and an integrated structural component disposed within the gel membrane. The integrated structural component may be selected from the group consisting of: a plurality of solid-state electrolyte particles, a nonwoven material, and combinations thereof.

In one aspect, the free-standing separating layer may include greater than or equal to about 50 wt. % to less than or equal to about 99.5 wt. % of the gel membrane, and greater than or equal to about 0.5 wt. % to less than or equal to about 50 wt. % of the integrated structural component.

In one aspect the plurality of solid-state electrolyte particles may be selected from the group consisting of: Li₇La₃Zr₂O₁₂, Li₃ₓLa_{2/3-x}TiO₃ (where 0<x<0.167), Li_{1.4}Al_{0.4}Ti_{1.6}(PO₄)₃, Li₁₊ₓAlₓGe₂₋ₓ(PO₄)₃ (where 0≤x≤2) (LAGP), Li₂₊₂ₓZn₁₋ₓGeO₄, where 0<x<1), aluminum (Al) or niobium (Nb) doped Li₇La₃Zr₂O₁₂, antimony (Sb) doped Li—La₃Zr₂O₁₂, gallium (Ga) substituted Li—La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), Li₃PS₄, Li₇P₃S₁₁, Li_{9.6}P₃S₁₂, Li₄SnS₄, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, Li₄SnS₄, Li₃N, Li—PN₄, LiSi₂N₃, LiBH₄, LiBH₄—LiX (where X=Cl, Br, or I), LiNH₂, Li₂NH, LiBH₄—LiNH₂, Li₃AlH₆, Li₃YCl₆, Li₃InCl₆, Li₃YBr₆, LiI, Li₂CdC₁₄, Li₂MgCl₄, LiCdI₄, Li₂ZnI₄, Li₃OCl, Li₂B₄O₇, Li₂O—B₂O₃—P₂O₅, SiO₂, Al₂O₃, TiO₂, ZrO₂, and combinations thereof.

In one aspect, the nonwoven material may be stable at temperatures greater than or equal to about 100° C. to less than or equal to about 500° ° C.

In one aspect, the nonwoven material may have an average thickness that is less than an average thickness of the free-standing separating layer.

In one aspect, the average thickness of the nonwoven material may be greater than or equal to about 1 micrometer to less than or equal to about 50 micrometers.

In one aspect, the average thickness of the free-standing separating layer may be greater than or equal to about 5 micrometers to less than or equal to about 100 micrometers.

In one aspect, the gel membrane may include greater than or equal to about 0.1 wt. % to less than or equal to about 50 wt. % of the polymer host, and greater than or equal to about 50 wt. % to less than or equal to about 99.5 wt. % of the liquid electrolyte.

In one aspect, the polymer host may be selected from the group consisting of: polyacrylonitrile (PAN), poly(ethylene oxide) (PEO), poly(vinylidene fluoride-co-hexafluoropropylene) (PVdF-HFP), poly(methyl methacrylate) (PMMA), carboxymethyl cellulose (CMC), polyvinylidene difluoride (PVDF), poly(vinyl alcohol) (PVA), polyvinylpyrrolidone (PVP), and combinations thereof.

In one aspect, the liquid electrolyte may include a lithium salt and a solvent. The lithium salt may be selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof. The solvent may be selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

In one aspect, the liquid electrolyte may include greater than 0 M to less than or equal to about 2 M of a first lithium salt and greater than 0 M to less than or equal to about 2 M of a second lithium salt. The first and second lithium salts may be independently selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof.

In one aspect, the liquid electrolyte may include a first solvent and a second solvent, where a mass ratio of the first solvent to the second solvent is (10-x):x (where 0.5≤x≤9.5). The first and second solvents may be independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

In various aspects, the present disclosure provides an electrochemical cell that cycles lithium ions. The electrochemical cell may include a positive electrode that includes a positive electroactive material, a negative electrode that includes a negative electroactive material, and a free-standing separating layer that may be disposed between the positive electrode and the negative electrode. The free-standing separating layer may include a gel membrane that includes a polymer host and a liquid electrolyte, and an integrated structural component disposed within the gel membrane. The integrated structural component may be selected from the group consisting of: a plurality of solid-state electrolyte particles, a nonwoven material, and a combination thereof.

In one aspect, the free-standing separating layer may include greater than or equal to about 50 wt. % to less than or equal to about 99.5 wt. % of the gel membrane, and greater than or equal to about 0.5 wt. % to less than or equal to about 50 wt. % of the integrated structural component.

In one aspect, the plurality of solid-state electrolyte particles may include solid-state electrolyte particles selected from the group consisting of: Li₇La₃Zr₂O₁₂, Li₃ₓLa_{2/3-x}TiO₃ (where 0<x<0.167), Li_{1.4}Al_{0.4}Ti_{1.6}(PO₄)₃, Li₁₊ₓAlₓGe₂₋ₓ(PO₄)₃ (where 0≤x≤2) (LAGP), Li₂₊₂ₓZn₁₋ₓGeO₄, where 0<x<1), aluminum (Al) or niobium (Nb) doped Li₇La₃Zr₂O₁₂, antimony (Sb) doped Li₇La₃Zr₂O₁₂, gallium (Ga) substituted Li—La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), Li₃PS₄, Li₇P₃S₁₁, Li_{9.6}P₃S₁₂, Li₄SnS₄, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, Li₄SnS₄, Li₃N, Li—PN₄, LiSi₂N₃, LiBH₄, LiBH₄—LiX (where X=Cl, Br, or I), LiNH₂, Li₂NH, LiBH₄—LiNH₂, Li₃AlH₆, Li₃YCl₆, Li₃InCl₆, Li₃YBr₆, LiI, Li₂CdC₁₄, Li₂MgCl₄, LiCdI₄, Li₂ZnI₄, Li₃OCl, Li₂B₄O₇, Li₂O—B₂O₃—P₂O₅, SiO₂, Al₂O₃, TiO₂, ZrO₂, and combinations thereof. The nonwoven material may be stable at temperatures greater than or equal to about 100° ° C. to less than or equal to about 500° C.

In one aspect, the nonwoven material may have an average thickness that is less than an average thickness of the free-standing separating layer.

In one aspect, the gel membrane may include greater than or equal to about 0.1 wt. % to less than or equal to about 50 wt. % of the polymer host, and greater than or equal to about 50 wt. % to less than or equal to about 99.5 wt. % of the liquid electrolyte.

In one aspect, the liquid electrolyte may include greater than 0 M to less than or equal to about 2 M of a first lithium salt and greater than 0 M to less than or equal to about 2 M of a second lithium salt. The first and second lithium salts may be independently selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof.

In one aspect, the liquid electrolyte may include a first solvent and a second solvent, where a mass ratio of the first solvent to the second solvent is (10-x):x (where 0.5≤x≤9.5). The first and second solvents may be independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

In one aspect, the electrochemical cell may include a positive electrode that includes a positive electroactive material, a negative electrode that includes a negative electroactive material, and a free-standing separating layer that may be disposed between the positive electrode and the negative electrode. The free-standing separating layer may include greater than or equal to about 50 wt. % to less than or equal to about 99.5 wt. % of a gel membrane, and greater than or equal to about 0.5 wt. % to less than or equal to about 50 wt. % of an integrated structural component disposed within the gel membrane. The gel membrane may include comprising greater than or equal to about 0.1 wt. % to less than or equal to about 50 wt. % of the polymer host and greater than or equal to about 50 wt. % to less than or equal to about 99.5 wt. % of the liquid electrolyte. The integrated structural component may be selected from the group consisting of: a plurality of solid-state electrolyte particles, a nonwoven material stable at temperatures greater than or equal to about 100° C. to less than or equal to about 500° C., and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including a free-standing separating layer in accordance with various aspects of the present disclosure;

FIG. 2 is a graphical illustration demonstrating the capacity of an example cell including a free-standing separating layer including a plurality of solid-state electrolyte particles in accordance with various aspects of the present disclosure; and

FIG. 3 is a graphical illustration demonstrating the capacity of an example cell including a free-standing separating layer including a nonwoven material in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to electrochemical cells that include gel polymer electrolytes, and more particularly, free-standing gel membranes (also referred to as free-standing separating layers), and methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

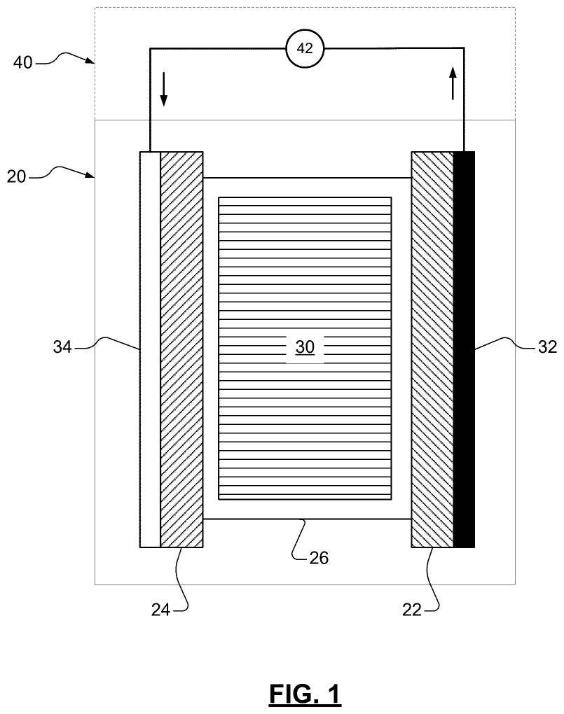

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a free-standing gel membrane (or separating layer) 26 disposed between the two electrodes 22, 24. The two electrodes 22, 24 may be in a solid and/or a liquid form and/or a hybrid thereof. For example, although not illustrated, in the instance of solid-state batteries and/or semi-solid-state batteries, the negative electrode 22 may include a plurality of solid-state negative electroactive material particles and/or the positive electrode 24 may include a plurality of solid-state positive electroactive material particles. Further, additionally or alternatively, the negative electrode 22 and/or the positive electrode 24 may include a plurality of solid-state electrolyte particles and/or a liquid electrolyte. In each instance, the free-standing gel membrane 26 provides electrical separation-prevents physical contact-between the electrodes 22, 24. The free-standing gel membrane 26 also provides a minimal resistance path for internal passage of lithium ions, and in certain instances, related anions, during cycling of the lithium ions. As further discussed below, the free-standing gel membrane 26 may include a gel membrane having an integrated structural component.

A first current collector 32 (e.g., a negative current collector) may be positioned at or near the negative electrode (also referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper, stainless steel, nickel, or any other appropriate electrically conductive material known to those of skill in the art.

A second current collector 34 (e.g., a positive current collector) may be positioned at or near the positive electrode (also referred to as a positive electroactive material layer) 24. The second current collector 34 together with the positive electrode 24 may be referred to as a positive electrode assembly. Although not illustrated, the skilled artisan will appreciate that, in certain variations, positive electroactive material layers 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the free-standing gel membrane 26 toward the positive electrode 24. The electrons flow through the external circuit 40 and the lithium ions migrate across the free-standing gel membrane 26 to form intercalated lithium at the positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode across the free-standing gel membrane 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, free-standing gel membrane 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the free-standing gel membrane 26.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharged. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, and as noted above, the free-standing gel membrane 26 includes a gel membrane having an integrated structural component. For example, the free-standing gel membrane 26 may include greater than or equal to about 50 wt. % to less than or equal to about 99.5 wt. % of the gel membrane and greater than or equal to about 0.5 wt. % to less than or equal to about 50 wt. % of the integrated structural component. The integrated structural component may help to enhance the mechanical strength of the gel membrane and to reduce or inhibit short circuit within the cell 20, while providing favorable lithium-ion conduction and enabling high-rate capabilities (e.g., at about 10 C).

In various aspects, the gel membrane may be a non-flowing membrane having an average thickness greater than or equal to about 5 micrometers (μm) to less than or equal to about 100 micrometers (μm), and in certain aspects, optionally about 40 micrometers (μm), and includes, for example, a polymer host or matrix and a first liquid electrolyte. For example, the gel membrane may include greater than or equal to about 0.1 wt. % to less than or equal to about 50 wt. %, and in certain aspects, optionally about 13 wt. %, of the polymer host and greater than or equal to about 50 wt. % to less than or equal to about 90 wt. %, and in certain aspects, optionally about 87 wt. %, of the first liquid electrolyte.

The polymer host may include, for example, polyacrylonitrile (PAN), poly(ethylene oxide) (PEO), poly(vinylidene fluoride-co-hexafluoropropylene) (PVdF-HFP), poly(methyl methacrylate) (PMMA), carboxymethyl cellulose (CMC), polyvinylidene difluoride (PVDF), poly(vinyl alcohol) (PVA), and/or polyvinylpyrrolidone (PVP). In certain variations, the polymer host may be selected from the group consisting of: polyacrylonitrile (PAN), poly(ethylene oxide) (PEO), poly(vinylidene fluoride-co-hexafluoropropylene) (PVdF-HFP), poly(methyl methacrylate) (PMMA), carboxymethyl cellulose (CMC), polyvinylidene difluoride (PVDF), poly(vinyl alcohol) (PVA), polyvinylpyrrolidone (PVP), and combinations thereof. For example, the polymer host may include a first polymer host and a second polymer host. The first polymer host may include polyacrylonitrile (PAN) and the second polymer host may include, for example, poly(vinylidene fluoride-co-hexafluoropropylene) (PVdF-HFP), poly(methyl methacrylate) (PMMA), carboxymethyl cellulose (CMC), polyvinylidene difluoride (PVDF), poly(vinyl alcohol) (PVA), and/or polyvinylpyrrolidone (PVP).

The first liquid electrolyte includes a lithium salt and a solvent. The lithium salt may include, for example, a lithium cation (Li⁺) and one or more anions selected from the group consisting of: hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl) (BETI), bis(oxalate)borate (BOB), difluoro(oxalato)borate (DFOB), bis(fluoromalonato) borate (BFMB), and combinations thereof. For example, in certain variations, the lithium salt may be selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof.

In certain variations, the lithium salt may include a first lithium salt and a second lithium salt. For example, the first liquid electrolyte may include greater than or equal to about 0 M to less than or equal to about 2 M of the first lithium salt, and greater than or equal to about 0 M to less than or equal to about 2 M of the second lithium salt. The first and second lithium salts may be independently selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof. By way of example, in certain variations, the first lithium salt may include lithium bis(trifluoromethanesulfonyl)imide (LiTFSI), and the second lithium salt may include lithium tetrafluoroborate (LiBF₄).

The solvent dissolves the lithium salt to enable good lithium-ion conductivity, while also exhibiting a low vapor pressure (e.g., less than about 10 mmHg at 25° C.) to match the cell fabrication process. The solvent includes, for example, carbonate solvents (such as ethylene carbonate (EC), propylene carbonate (PC), glycerol carbonate, vinylene carbonate, fluoroethylene carbonate, 1,2-butylene carbonate, and the like), lactones (such as γ-butyrolactone (GBL), δ-valerolactone, and the like), nitriles (such as succinonitrile, glutaronitrile, adiponitrile, and the like), sulfones (such as tetramethylene sulfone, ethyl methyl sulfone, vinyl sulfone, phenyl sulfone, 4-fluorophenyl sulfone, benzyl sulfone, and the like), ethers (such as triethylene glycol dimethylether (triglyme, G3), tetraethylene glycol dimethylether (tetraglyme, G4), 1,3-dimethyoxy propane, 1,4-dioxane, and the like), phosphates (such as triethyl phosphate, trimethyl phosphate, and the like), and/or ionic liquids including, for example, ionic liquid cations (such as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as bis(trifluoromethanesulfonyl)imide (TFSI), bis(fluorosulfonyl imide (FSI), and the like).

For example, in certain variations, the solvent is selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids, and combinations thereof, where the ionic liquids include cations selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof.

In certain variations, the solvent includes a first solvent and a second solvent. For example, a mass ratio of the first solvent to the second solvent in the first liquid electrolyte may be (10-x):x, where 0.5≤x≤9.5. The first and second solvents may be independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids, and combinations thereof, where the ionic liquids include cations selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof. By way of example, in certain variations, the first solvent may include ethylene carbonate (EC), and the second solvent may include γ-butyrolactone (GBL).

In certain variations, the first liquid electrolyte may also include an electrolyte additive. For example, the first liquid electrolyte may include greater than or equal to about 0 wt. % to less than or equal to about 10 wt. % of the electrolyte additive. The electrolyte additive may include, for example, 1,3,2-dioxathiolane, 2,2-dioxide (DTD), vinyl ethylene carbonate (VEC), vinylene carbonate (VC), fluorosulfonyl isocyanate (FI), trimethyl borate (TMB), tris(trimethylsilyl) phosphite (TTSPi), methylene methane disulfonate (MMDS), and/or prop-1-ene-1,3,sultone. For example, in certain variations, the electrolyte additive may be selected form the group consisting of: 1,3,2-dioxathiolane, 2,2-dioxide (DTD), vinyl ethylene carbonate (VEC), vinylene carbonate (VC), fluorosulfonyl isocyanate (FI), trimethyl borate (TMB), tris(trimethylsilyl) phosphite (TTSPi), methylene methane disulfonate (MMDS), prop-1-ene-1,3,sultone, and combinations thereof.

In various aspects, the integrated structural component may be an inorganic component. For example, in certain variations, the integrated structural component may include a first plurality of solid-state electrolyte particles having good chemical or electrochemical stability with the gel membrane, so there is no undesirable side reactions between the solid-state electrolyte particles and the gel membrane. The solid-state electrolyte particles may be substantially homogeneously (i.e., evenly) distributed within the gel membrane to form the free-standing gel membrane. The solid-state electrolyte particles may have an average particle size greater than or equal to about 1 nanometer (nm) to less than or equal to about 20 micrometers (μm), and in certain aspects, optionally greater than or equal to about 100 nanometer (nm) to less than or equal to about 10 micrometers (μm). In certain variations, incorporation of the solid-state electrolyte particles may slightly increase the ionic conductivity. For example, in certain instances, the gel membrane may have an ionic conductivity of about 1.66 ms/cm at about 25° C., while the free-standing gel membrane 26 including an integrated structural component defined by a first plurality of solid-state electrolyte particles may have an ionic conductivity of about 1.8 ms/cm at about 25° C.

The solid-state electrolyte particles may include lithium-ion conducting active materials having, for example, a lithium-ion conductivity greater than or equal to about 0.001 ms/cm at about 25° C. or lithium-ion non-conducting inactive materials having, for example, a lithium-ion conductivity less than 0.001 ms/cm at about 25° C. The active materials may include, for example, oxide-based solid-state particles (such as garnet type solid-state particles (e.g., Li₇La₃Zr₂O₁₂ (LLZO)), perovskite type solid-state particles (e.g., Li₃ₓLa_{2/3-x}TiO₃, where 0<x≤0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1)), metal-doped or aliovalent-substituted oxide solid-state particles (such as aluminum (Al) or niobium (Nb) doped Li₇La₃Zr₂O₁₂, antimony (Sb) doped Li—La₃Zr₂O₁₂, gallium (Ga) substituted Li—La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y<3)), sulfide-based solid-state particles (such as Li₂S—P₂S₅ systems (e.g., Li₃PS₄, Li₇P₃S₁₁, and Li_{9.6}P₃S₁₂), Li₂S—SnS₂ systems (e.g., Li₄SnS₄), Li₂S—P₂S₅-MOx systems (where M is selected from the group consisting of: P, Sn, Mg, Zn, and combinations thereof and 0<x<2), Li₂S—P₂S₅-MSx systems (where M is P, Sn, Mg, Zn, and combinations thereof and 0<x<2), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉₀₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, and/or Li₄SnS₄), nitride-based solid-state particles (such as Li₃N, Li₇PN₄, and/or LiSi₂N₃), hydride-based solid-state particles (such as LiBH₄, LiBH₄—LiX (where X=Cl, Br, or I), LiNH₂, Li₂NH, LiBH₄—LiNH₂, and/or Li₃AlH₆), halide-based solid-state particles (such as Li₃YCl₆, Li₃InCl₆, Li₃YBr₆, LiI, Li₂CdC₁₄, Li₂MgCl₄, LiCdI₄, Li₂ZnI₄, and/or Li₃OCl), and/or borate-based solid-state particles (Li₂B₄O₇ and/or Li₂O—B₂O₃—P₂O₅). The inactive materials may include ceramic oxides (such as SiO₂, Al₂O₃, TiO₂, and/or ZrO₂).

In certain variations, the solid-state electrolyte particles may be selected from the group consisting of: Li₇La₃Zr₂O₁₂, Li₃ₓLa_{2/3-x}TiO₃ (where 0<x<0.167), Li_{1.4}Al_{0.4}Ti_{1.6}(PO₄)₃, Li₁₊ₓAlₓGe₂₋ₓ(PO₄)₃ (where 0≤x≤2) (LAGP), Li₂₊₂ₓZn₁₋ₓGeO₄, where 0<x<1), aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x≤2 and 0<y<3), Li₃PS₄, Li₇P₃S₁₁, Li_{9.6}P₃S₁₂, Li₄SnS₄, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, Li₄SnS₄, Li₃N, Li₇PN₄, LiSi₂N₃, LiBH₄, LiBH₄—LiX (where X=Cl, Br, or I), LiNH₂, Li₂NH, LiBH₄—LiNH₂, Li₃AlH₆, Li₃YCl₆, Li₃InCl₆, Li₃YBr₆, LiI, Li₂CdC₁₄, Li₂MgCl₄, LiCdI₄, Li₂ZnI₄, Li₃OCl, Li₂B₄O₇, Li₂O—B₂O₃—P₂O₅, SiO₂, Al₂O₃, TiO₂, ZrO₂, and combinations thereof.

In other aspects, the integrated structural component may be an organic component. For example, in certain variations, the integrated structural component may include a nonwoven material, meaning that it has not been subjected to a weaving process (e.g., not being woven having warp and weft woven fibers or filaments or knitted). The nonwoven material may have good mechanical strength, good chemical stability with the gel membrane, and high thermal stability that matches the hot-casting process. Non-woven materials include those having fibers or filaments that may be bonded, such as felts, mats, crimped materials, membranes, and the like. The nonwoven materials may be porous, for example, having a porosity greater than or equal to about 5 vol. % to less than or equal to about 95 vol. %, and in certain aspects, optionally greater than or equal to about 50 vol. % to less than or equal to about 90 vol. %. For example, in certain variations, the nonwoven material may be a polyester membrane, a cellulose membrane, polyvinylidene fluoride (PVDF) membrane, polytetrafluoroethylene membrane, polyethylene terephthalate membrane, and/or porous polyimide membrane. In other variations, the nonwoven material may be a polyolefin-base porous separator including, for example, polyacetylene, polypropylene (PP), and/or polyethylene (PE) (e.g., dual-layered type: polypropylene-polyethylene and/or three-layered type: polypropylene-polyethylene-polypropylene). In certain variations, the polyolefin-based separator may include one or more ceramic coatings (e.g., SiO₂). In still other variations, the nonwoven material may include other high-temperature stable porous members. For example, the nonwoven material may experience limited or no side reactions, such as gel membrane decomposition or oxidation/reduction. The nonwoven materials may be stable, for example, at temperatures greater than or equal to about 100° C. to less than or equal to about 500° C. For example, the nonwoven material may include polyimide (PI) nanofiber-based nonwovens, co-polyimide-coated polyethylene separators, expanded polytetrafluoroethylene reinforced polyvinylidenefluoride-hexafluoropropylene separator, sandwiched-structure polyvinylidene fluoride (PVDF)/poly(m-phenylene isophthalamide) (PMIA)/polyvinylidene fluoride (PVDF) nanofibrous separators, and the like. In each variations, the nonwoven material may have an average thickness that is smaller than the average thickness of the gel membrane, such that the gel membrane overcoats the nonwoven material. For example, in certain variations, the nonwoven material may have an average thickness greater than or equal to about 1 micrometers (μm) to less than or equal to about 50 micrometers (μm).

With renewed reference to FIG. 1, the negative electrode 22 may be formed from a lithium host material that is capable of functioning as a negative terminal of a lithium-ion battery. In certain variations, the negative electrode 22 may be defined by a film. For example, the negative electrode may be defined by a lithium metal foil. Although not illustrated, it should be recognized that, in other variations, the negative electrode 22 may be defined by a plurality of negative electroactive material particles. Such negative electroactive material particles may be disposed in one or more layers so as to define the three-dimensional structure of the negative electrode 22. In each variation, the negative electrode 22 may include a first electrolyte. The first electrolyte may be in a solid and/or a liquid form and/or a hybrid thereof. For example, in certain variations, the negative electrode 22 may include a second liquid electrolyte. The second liquid electrolyte may be the same as or different from the first liquid electrolyte as defining the gel membrane. In other variations, the negative electrode 22 may include a second plurality of solid-state electrolyte particles. The second plurality of solid-state electrolyte particles may be the same as or different from the first plurality of solid-state electrolyte particles. In each variation, the negative electrode 22 may have a thickness greater than or equal to about 10 micrometers (μm) to less than or equal to about 400 micrometers (μm).

In various aspects, the negative electrode 22 may include a lithium-containing negative electroactive material, such as a lithium alloy and/or a lithium metal. In other variations, the negative electrode 22 may include, for example only, carbonaceous negative electroactive materials (such as, graphite, hard carbon, soft carbon, and/or the like) and/or metallic negative electroactive materials (such as tin, aluminum, magnesium, germanium, and alloys thereof, and/or the like). In further variations, the negative electrode 22 may include a silicon-based negative electroactive material. In still further variations, the negative electrode 22 may be a composite electrode including a combination of negative electroactive materials. For example, the negative electrode 22 may include a first negative electroactive material and a second negative electroactive material. In certain variations, a mass ratio of the first negative electroactive material to the second negative electroactive material may be greater than or equal to about 5:95 to less than or equal to about 95:5. The first negative electroactive material may be a volume-expanding negative electroactive material including, for example, silicon, aluminum, germanium, and/or tin. The second negative electroactive material may include a carbonaceous negative electroactive material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In various aspects, the negative electrode 22 may further include an electronically conductive material (i.e. conductive additive) that provides an electron conductive path and/or a polymeric binder material that improves the structural integrity of the negative electrode 22. For example, the negative electrode 22 may include greater than or equal to about 30 wt. % to less than or equal to about 98 wt. % of the negative electroactive material; greater than or equal to about 0 wt. % to less than or equal to about 50 wt. %, and in certain aspects, optionally greater than 0 wt. % to less than or equal to about 50 wt. %, of the second plurality of solid-state electrolyte particles; greater than or equal to about 0 wt. % to less than or equal to about 30 wt. %, and in certain aspects, optionally greater than 0 wt. % to less than or equal to about 30 wt. %, of the conductive additive; and greater than or equal to about 0 wt. % to less than or equal to about 20 wt. %, and in certain aspects, greater than 0 wt. % to less than or equal to about 20 wt. %, of the binder.

Example polymeric binders include polyimide, polyamic acid, polyamide, polysulfone, polyvinylidene difluoride (PVdF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. Although not illustrated, it should be recognized that the positive electrode 24 may be defined by a plurality of positive electroactive material particles. Such positive electroactive material particles may be disposed in one or more layers so as to define the three-dimensional structure of the positive electrode 24. In each variation, the positive electrode 24 may include a second electrolyte. Like the first electrolyte in the negative electrode 22, the second electrolyte may be in a solid and/or a liquid form and/or a hybrid thereof. For example, in certain variations, the positive electrode 24 may include a third liquid electrolyte. The third liquid electrolyte may be the same as or different from the first liquid electrolyte as defining the gel membrane. The third liquid electrolyte may be the same as or different from the second liquid electrolyte as included in the negative electrode 22. In other variations, the positive electrode 24 may include a third plurality of solid-state electrolyte particles. The third plurality of solid-state electrolyte particles may be the same as or different from the first plurality of solid-state electrolyte particles and/or the second plurality of solid-state electrolyte particles. In each variation, the positive electrode 24 may have a thickness greater than or equal to about 10 micrometers (μm) to less than or equal to about 400 micrometers (μm).

In various aspects, the positive electroactive material includes a layered oxide represented by LiMeO₂, where Me is a cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is cobalt (Co), nickel (Ni), manganese (Mn), iron (Fe), aluminum (Al), vanadium (V), or combinations thereof. In still further variations, the positive electrode 24 may be a composite electrode including a combination of positive electroactive materials. For example, the positive electrode 24 may include a first positive electroactive material and a second electroactive material. A mass ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxides, one or more tavorites, or combinations thereof.

In various aspects, the positive electrode 24 may further include an electronically conductive material (i.e. conductive additive) that provides an electron conductive path and/or a polymeric binder material that improves the structural integrity of the positive electrode 24. For example, the positive electrode 24 may include greater than or equal to about 30 wt. % to less than or equal to about 98 wt. % of the positive electroactive material; greater than or equal to about 0 wt. % to less than or equal to about 50 wt. %, and in certain aspects, optionally greater than 0 wt. % to less than or equal to about 50 wt. %, of the third plurality of solid-state electrolyte particles; greater than or equal to about 0 wt. % to less than or equal to about 30 wt. %, and in certain aspects, optionally greater than 0 wt. % to less than or equal to about 30 wt. %, of the conductive additive; and greater than or equal to about 0 wt. % to less than or equal to about 20 wt. %, and in certain aspects, greater than 0 wt. % to less than or equal to about 20 wt. %, of the binder. The conductive additive and/or binder as included in the positive electrode 24 may be the same as or different from the conductive additive and/or binder as included in the negative electrode 22.

Certain features of the current technology are further illustrated in the following non-limiting examples.

### Example 1

Example batteries and battery cells may be prepared in accordance with various aspects of the present disclosure.

For example, an example cell 210 may include a free-standing gel membrane having a gel membrane and an integrated structural component prepared in accordance with various aspects of the present disclosure. For example, the free-standing gel membrane may include an integrated structural component defined by a plurality of solid-state electrolyte particles. The plurality of solid-state electrolyte particles may include Li₇La₃Zr₂O₁₂ (LLZO). A comparative cell 220 may include a gel membrane, like the gel membrane included in the example cell 210, but omits the free-standing gel membrane. The example cell 210 and the comparative cell 220 may each include a positive electrode including LiMn_{0.7}Fe_{0.3}PO₄, and a negative electrode including graphite particles.

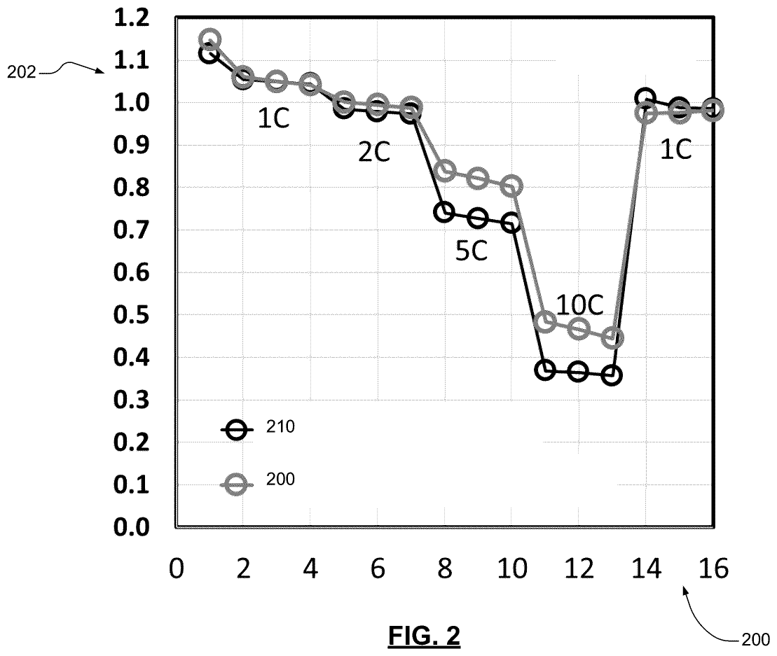

FIG. 2 is a graphical illustration demonstrating the capacity at 25° C. of the example cell 210 as compared to the comparative cell 220, where the x-axis 200 represents cycle number, and the y-axis 202 represents cell capacity (mAh). As illustrated the example cell 210 has improved rate capabilities, especially at 10 C.

### Example 2

Example batteries and battery cells may be prepared in accordance with various aspects of the present disclosure.

For example, an example cell 310 may include a free-standing gel membrane having a gel membrane and an integrated structural component prepared in accordance with various aspects of the present disclosure. For example, the free-standing gel membrane may include an integrated structural component defined by a nonwoven material. The example cell 310 may also include a positive electrode including LiMn_{0.7}Fe_{0.3}PO₄, and a negative electrode including graphite particles.

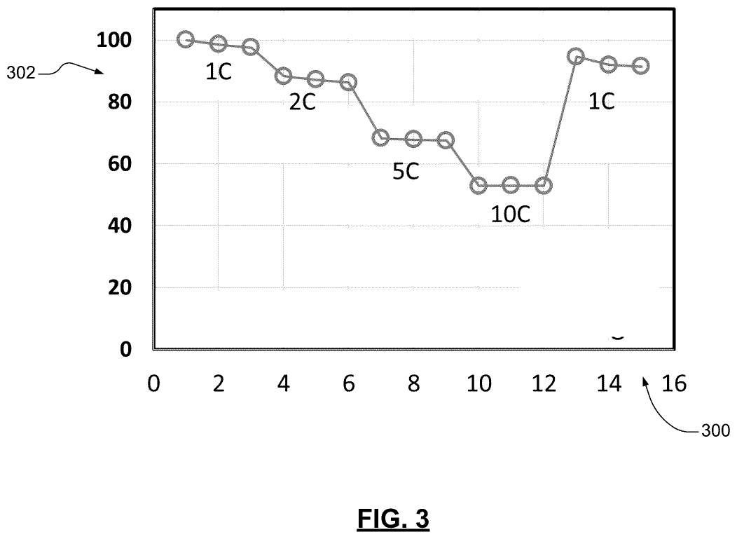

FIG. 3 is a graphical illustration demonstrating the capacity retention at 25° C. of the example cell 310, where the x-axis 300 represents cycle number, and the y-axis 302 represents capacity retention based on the capacity at 1 C. As illustrated, the example cell 310 has delivers improved capabilities, especially at 10 C.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A free-standing separating layer for an electrochemical cell, the free-standing separating layer comprising:
a gel membrane comprising a polymer host and a liquid electrolyte; and
an integrated structural component disposed within the gel membrane, the integrated structural component selected from the group consisting of: a plurality of solid-state electrolyte particles, a nonwoven material, and combinations thereof.

2. The free-standing separating layer of claim 1, wherein the free-standing separating layer comprises greater than or equal to about 50 wt. % to less than or equal to about 99.5 wt. % of the gel membrane, and greater than or equal to about 0.5 wt. % to less than or equal to about 50 wt. % of the integrated structural component.

3. The free-standing separating layer of claim 1, wherein the plurality of solid-state electrolyte particles are selected from the group consisting of: Li₇La₃Zr₂O₁₂, Li₃ₓLa_{2/3-x}TiO₃ (where 0<x≤0.167), Li_{1.4}Al_{0.4}Ti_{1.6}(PO₄)₃, Li₁₊ₓAlₓGe₂₋ₓ(PO₄)₃ (where 0≤x≤2) (LAGP), Li₂₊₂ₓZn₁₋ₓGeO₄, where 0<x≤1), aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x≤2 and 0<y<3), Li₃PS₄, Li₇P₃S₁₁, Li_{9.6}P₃S₁₂, Li₄SnS₄, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, Li₄SnS₄, Li₃N, Li₇PN₄, LiSi₂N₃, LiBH₄, LiBH₄—LiX (where X=Cl, Br, or I), LiNH₂, Li₂NH, LiBH₄—LiNH₂, Li₃AlH₆, Li₃YCl₆, Li₃InCl₆, Li₃YBr₆, LiI, Li₂CdC₁₄, Li₂MgCl₄, LiCdI₄, Li₂ZnI₄, Li₃OCl, Li₂B₄O₇, Li₂O—B₂O₃—P₂O₅, SiO₂, Al₂O₃, TiO₂, ZrO₂, and combinations thereof.

4. The free-standing separating layer of claim 1, wherein the nonwoven material is stable at temperatures greater than or equal to about 100° C. to less than or equal to about 500° C.

5. The free-standing separating layer of claim 1, wherein the nonwoven material has an average thickness that is less than an average thickness of the free-standing separating layer.

6. The free-standing separating layer of claim 5, wherein the average thickness of the nonwoven material is greater than or equal to about 1 micrometer to less than or equal to about 50 micrometers.

7. The free-standing separating layer of claim 1, wherein the average thickness of the free-standing separating layer is greater than or equal to about 5 micrometers to less than or equal to about 100 micrometers.

8. The free-standing separating layer of claim 1, wherein the gel membrane comprises greater than or equal to about 0.1 wt. % to less than or equal to about 50 wt. % of the polymer host, and greater than or equal to about 50 wt. % to less than or equal to about 99.5 wt. % of the liquid electrolyte.

9. The free-standing separating layer of claim 1, wherein the polymer host is selected from the group consisting of: polyacrylonitrile (PAN), poly(ethylene oxide) (PEO), poly(vinylidene fluoride-co-hexafluoropropylene) (PVdF-HFP), poly(methyl methacrylate) (PMMA), carboxymethyl cellulose (CMC), polyvinylidene difluoride (PVDF), poly(vinyl alcohol) (PVA), polyvinylpyrrolidone (PVP), and combinations thereof.

10. The free-standing separating layer of claim 1, wherein the liquid electrolyte comprises:
a lithium salt selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof; and
a solvent selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

11. The free-standing separating layer of claim 1, wherein the liquid electrolyte comprises greater than 0 M to less than or equal to about 2 M of a first lithium salt and greater than 0 M to less than or equal to about 2 M of a second lithium salt, wherein the first and second lithium salts are independently selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof.

12. The free-standing separating layer of claim 1, wherein the liquid electrolyte comprises a first solvent and a second solvent, wherein a mass ratio of the first solvent to the second solvent is (10-x):x (where 0.5≤x≤9.5) and the first and second solvents are independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

13. An electrochemical cell that cycles lithium ions, the electrochemical cell comprising:
a positive electrode comprising a positive electroactive material;
a negative electrode comprising a negative electroactive material; and
a free-standing separating layer disposed between the positive electrode and the negative electrode, wherein the free-standing separating layer comprises:
a gel membrane comprising a polymer host and a liquid electrolyte, and
an integrated structural component disposed within the gel membrane, the integrated structural component selected from the group consisting of: a plurality of solid-state electrolyte particles, a nonwoven material, and a combination thereof.

14. The electrochemical cell of claim 13, wherein the free-standing separating layer comprises greater than or equal to about 50 wt. % to less than or equal to about 99.5 wt. % of the gel membrane, and greater than or equal to about 0.5 wt. % to less than or equal to about 50 wt. % of the integrated structural component.

15. The electrochemical cell of claim 13, wherein the plurality of solid-state electrolyte particles comprises solid-state electrolyte particles selected from the group consisting of: Li₇La₃Zr₂O₁₂, Li₃ₓLa_{2/3-x}TiO₃ (where 0≤x≤0.167), Li_{1.4}Al_{0.4}Ti_{1.6}(PO₄)₃, Li₁₊ₓAlₓGe₂₋ₓ(PO₄)₃ (where 0≤x≤2) (LAGP), Li₂₊₂ₓZn₁₋ₓGeO₄, where 0<x<1), aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x≤2 and 0<y<3), Li₃PS₄, Li₇P₃S₁₁, Li_{9.6}P₃S₁₂, Li₄SnS₄, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, Li₄SnS₄, Li₃N, Li₇PN₄, LiSi₂N₃, LiBH₄, LiBH₄—LiX (where X=Cl, Br, or I), LiNH₂, Li₂NH, LiBH₄—LiNH₂, Li₃AlH₆, Li₃YCl₆, Li₃InCl₆, Li₃YBr₆, LiI, Li₂CdC₁₄, Li₂MgCl₄, LiCdI₄, Li₂ZnI₄, Li₃OCl, Li₂B₄O₇, Li₂O—B₂O₃—P₂O₅, SiO₂, Al₂O₃, TiO₂, ZrO₂, and combinations thereof; and
the nonwoven material is stable at temperatures greater than or equal to about 100° C. to less than or equal to about 500° C.

16. The electrochemical cell of claim 13, wherein the nonwoven material has an average thickness that is less than an average thickness of the free-standing separating layer.

17. The electrochemical cell of claim 13, wherein the gel membrane comprises greater than or equal to about 0.1 wt. % to less than or equal to about 50 wt. % of the polymer host, and greater than or equal to about 50 wt. % to less than or equal to about 99.5 wt. % of the liquid electrolyte.

18. The electrochemical cell of claim 13, wherein the liquid electrolyte comprises greater than 0 M to less than or equal to about 2 M of a first lithium salt and greater than 0 M to less than or equal to about 2 M of a second lithium salt, wherein the first and second lithium salts are independently selected from the group consisting of: lithium hexafluoroarsenate, lithium hexafluorophosphate, lithium bis(fluorosulfonyl)imide (LiFSI), lithium perchlorate, lithium tetrafluoroborate (LiBF₄), lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate, lithium difluoro(oxalato)borate, lithium bis(fluoromalonato)borate, and combinations thereof.

19. The electrochemical cell of claim 13, wherein the liquid electrolyte comprises a first solvent and a second solvent, wherein a mass ratio of the first solvent to the second solvent is (10-x):x (where 0.5≤x≤9.5) and the first and second solvents are independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, as succinonitrile, glutaronitrile, adiponitrile, tetramethylene sulfone, ethyl methyl sulfone, triethylene glycol dimethylether (triglyme, G3), tetraethylene glycol dimethylether (tetraglyme, G4), 1,3-dimethyoxy propane, 1,4-dioxane, vinyl sulfone, phenyl sulfone, 4-fluorophenyl sulfone, benzyl sulfone, triethyl phosphate, trimethyl phosphate, ionic liquids comprising a cation selected from the group consisting of: as 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and combinations thereof and anions selected from the group consisting of: bis(trifluoromethanesulfonyl)imide (TFSI), bis(fluorosulfonyl imide (FSI), and combinations thereof, and combinations thereof.

20. An electrochemical cell that cycles lithium ions, the electrochemical cell comprising:
a positive electrode comprising a positive electroactive material;
a negative electrode comprising a negative electroactive material; and
a free-standing separating layer disposed between the positive electrode and the negative electrode, wherein the free-standing separating layer comprises:
greater than or equal to about 50 wt. % to less than or equal to about 99.5 wt. % of a gel membrane comprising greater than or equal to about 0.1 wt. % to less than or equal to about 50 wt. % of the polymer host and greater than or equal to about 50 wt. % to less than or equal to about 99.5 wt. % of the liquid electrolyte, and
greater than or equal to about 0.5 wt. % to less than or equal to about 50 wt. % of an integrated structural component disposed within the gel membrane, the integrated structural component selected from the group consisting of: a plurality of solid-state electrolyte particles, a nonwoven material stable at temperatures greater than or equal to about 100° C. to less than or equal to about 500° C., and combinations thereof.
